(19) United States
(12) Patent Application Publication
(10) Pub. No.: US 2005/0167401 A1
(43) Pub. Date: Aug. 4, 2005

(54) Treatment of spot welded joints for fatigue life improvement

(75) Inventor: Eric T. Easterbrook, Kent, WA (US)

Correspondence Address: R REAMS GOODLOE, JR. & R. REAMS GOODLOE, P.S., 24722 104TH. AVENUE S.E., SUITE 102, KENT, WA, 98030-5322, US

(73) Assignee: STRESSWAVE, INC.

(21) Appl. No.: 11/050,166

(22) Filed: Feb. 2, 2005

Related U.S. Application Data
(60) Provisional application No. 60/541,358, filed on Feb. 2, 2004.

(51) Int. Cl. B23K 11/11

(52) U.S. Cl. 219/78.16

(57) ABSTRACT

A method for cold working spot welded structures to improve fatigue life, and structures made by the method. Partially finished structures are provided assembled and joined by a spot weld nugget. Opposing indenters, or an indenter and a backing anvil, are used to squeeze the spot weld nugget to form one or two cold working dimples, respectively. Residual compressive stress is imparted in the workpiece, resulting in increased fatigue life.

### RELATED PATENT APPLICATIONS

This patent application claims priority from prior U.S. Provisional Patent Application Ser. No. 60/541,358, filed on Feb. 2, 2004, entitled TREATMENT OF SPOT WELDED JOINTS FOR FATIGUE IMPROVEMENT, the disclosure of which is incorporated herein in its entirety, including the specification, drawings, and claims, by this reference.

### COPYRIGHT RIGHTS IN THE DRAWING

A portion of the disclosure of this patent document contains material that is subject to copyright protection. The applicant no objection to the facsimile reproduction by anyone of the patent document or the patent disclosure, as it appears in the Patent and Trademark Office patent file or records, but otherwise reserves all copyright rights whatsoever.

1. Technical Field

This invention relates to spot weld joints, and more particularly, to spot welded joints having improved mechanical properties, especially improved fatigue life.

2. Background

Resistance spot welding, commonly known as “spot welding,” is widely used for joining metallic sheets together. Metallic sheets joined by spot welding typically are utilized to provide the primary structural components in many industrial assemblies or manufactured objects including, but not limited to, automobiles, trucks, railway rolling stock, and ships. Presently, spot welding is one of the predominant means of body structure assembly in the automotive industry. Consequently, in automotive assembly operations, optimization of the number of spot welds, and selection of the location of spot welds utilized, are major economic considerations.

Basically, spot welds are formed by passing an electrical current through adjacent, overlapping metallic sheets. Typically, the heat for the weld is provided through the use of electric current passing through opposing electrodes. As the temperature of a localized area of the metallic sheets between the electrodes is elevated by the metal's resistance to the flow of electric current, a portion of the metal is heated to a plastic state. As the temperature of the metal increases, a liquid pool of metal forms at the interface of the overlapping metallic sheets. The liquid pool of metal is typically about the same diameter as the diameter of the electrode tip. Spot weld joints created by this method form welds of up to about 8 mm in diameter, known as “buttons”, “fused nuggets” or “weld nuggets” typically identifiable by a slight surface depression, increased surface roughness, and discoloration at the spot weld location.

In typical spot welding applications, the opposing electrodes also squeeze the metallic sheets together prior to and during the flow of electric current. The squeeze force acting on the tips of the electrodes improves weld quality and may locally deform the surfaces of overlapping metallic sheets and form small depressions.

The spot welding process typically consists of several sequential phases, including squeeze, weld, and hold cycles. The main spot welding parameters are electrode contact diameter, squeeze force, current level, weld time duration, and hold time duration. Each of these parameters must be controlled effectively to produce a spot weld of good quality.

However, even when controlled effectively as currently practiced in the art, the thermal cycle of the spot welding process produces undesirable residual stresses around the weld nugget. Physically, as the hot weld nugget cools to ambient temperature, it shrinks radially inward toward the center of the weld nugget. Such shrinkage produces undesirable tensile residual radial stresses in the weld nugget and in the surrounding material, leading to significant reductions in desirable mechanical properties, corrosion resistance, and fatigue life, when such properties in the weld nugget are compared to similar base sheet mechanical properties.

Another factor in resistance spot welds which contributes to the low fatigue life of resistance spot welds is the presence of a built-in notch between the joined sheets. At the periphery of the weld nugget, where the sheets are not joined, a notch is formed between the sheets, wherein the root of the between sheet notch is located at the weld nugget boundary. The notch geometry is usually quite sharp, and results in an undesirable residual stress concentation , which contributes to reduced fatigue life.

Some efforts have been made toward improving resistance spot weld quality, since such spot welds are prominent sites for the origination of cracks and defects in equipment manufactured using quantities of such joints. Cracks originating from spot weld nuggets can reduce structural integrity, and as a result, reduce product safety and reliability. Further, cracked resistance spot welds lead to an increase in structural noise and vibration, which lead to increases in warranty costs, especially for automobiles.

Improvements in fatigue life can be achieved by imparting beneficial residual compressive stresses in metal structures. Cold working is a generic term that describes a number of processes that improve fatigue life by introducing beneficial stresses in such structures. Shot peening is one such cold working process. In shot peening, the surface of a metal is impinged by a plurality of metallic or ceramic pellets that are projected at high velocity, either mechanically or through air pressure. The impact of the pellets against a metallic surface produces a thin layer of beneficial compressive stresses which improves fatigue life. However, since cracks at resistance spot welds typically form at the notch, i.e. interior to the surface of the materials being joined, surface cold working methods such as shot peening have limited effectiveness for spot welds.

Laser shock processing is another cold working process for inducing residual compressive stresses at the surfaces of metal structures. For thin structures it might improve the residual compressive stress through the thickness of a workpiece. In the case of a resistance spot welded joint, such treatment might result in improved fatigue life. However, laser shock processing is presently a rather costly process and is not used for high volume production of fatigue resistant structures.

In my prior fatigue enhancement work, I developed a cold working technique, now known as the StressWave brand cold working process, that uses specially shaped indenters to on the opposed surfaces of fastened joints of material, to produce beneficial residual compressive stresses through the entire thickness of materials which are joined, thereby improving the fatigue life of such structures. The StressWave process has been used successfully on fastened joints where a fastener hole is produced after the StressWave cold working process has been utilized on the workpieces to be joined. In the StressWave process as applied to installing a fastener, an indenter is used to dimple the surfaces of a workpiece at a location where a fastener is to be installed. The process works on the surfaces of the workpieces. Consequently, the development of the desired residual stress by the StressWave cold working process is not dependent on machining the hole or on the fastener installation. StressWave brand cold work processing has been performed by actuating the indenters on the opposing surfaces of a metallic workpiece at a quasi-static speed, as well as at high speed where the process is completed in as little as 200 milliseconds. And, the StressWave brand cold working process has been found applicable to virtually all metallic materials. Background on earlier uses for the StressWave brand cold working process can be found in issued U.S. Pat. No. 6,230,537 issued May 15, 2001, U.S. Pat. No. 6,389,865 issued May 21, 2002, and U.S. Pat. No. 6,615,636 issued Sep. 9, 2003, the disclosures of each of which are incorporated herein in their entirety by this reference.

In summary, with respect to structures which utilize resistance spot welding, especially items such as automobiles that utilize large number of resistance spot welds to assemble structures, there remains an urgent and as yet unfilled need for a method of manufacturing which can easily and reliably improve the fatigue life of resistance spot welded joints. Moreover, it would be advantageous to provide a method for improving the fatigue life of resistance spot welded structures which allows continued use of cost effective materials of construction such as carbon steel commonly found in automobile assembly, or similar alternate materials which are easily and cheaply available. And, it would be advantageous to provide a method for improving fatigue life of resistance spot welded structures which is easily adaptable to automated manufacturing procedures, such as automotive assembly lines.

### BRIEF DESCRIPTION OF THE DRAWING

In order to enable the reader to attain a more complete appreciation of the invention, and of the novel features and the advantages thereof, attention is directed to the following detailed description when considered in connection with the accompanying figures of the drawing, wherein:

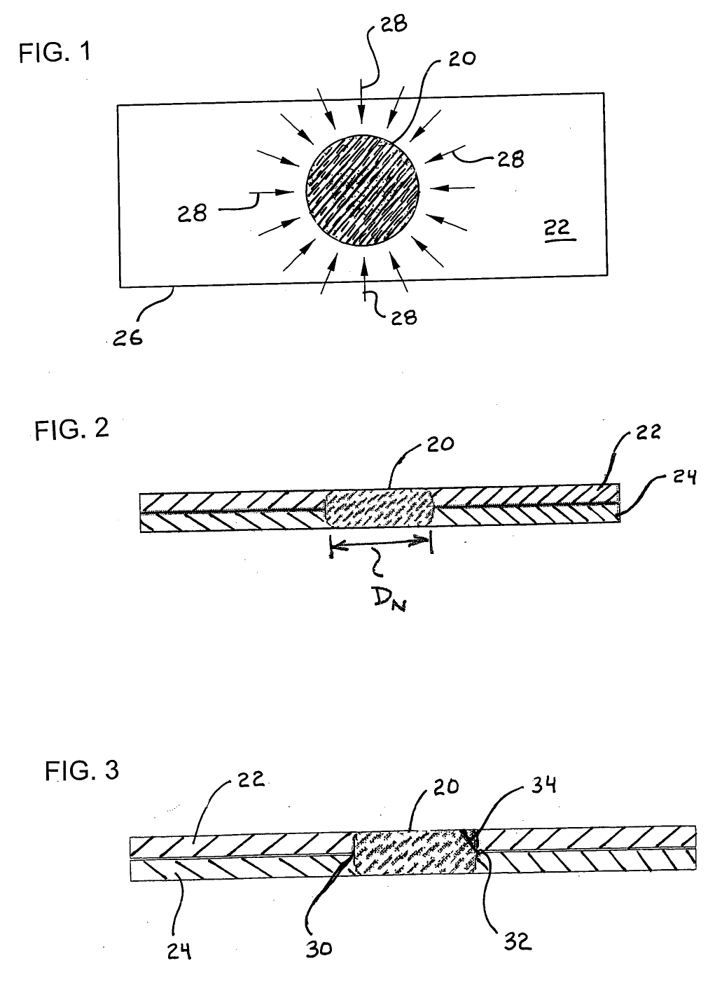

FIG. 1 is a plan view of a workpiece in which first and second metal workpieces have been welded together using a resistance spot weld technique, showing the weld nugget and indicating the radial inward shrinkage in the workpiece which leads to adverse residual stress and reduction of fatigue life in such prior art structures.

FIG. 2 is a vertical cross sectional view of the workpiece just illustrated in FIG. 1, now showing the cross-section of the weld nugget which resulted form spot welding of first and second metal workpieces.

FIG. 3 is another detailed vertical cross-sectional view of the spot welded workpiece just shown in FIGS. 1 and 2, but now additionally showing the notches formed by creation of the weld nugget, and the typical fatigue crack location and orientation which occurs in such prior art workpieces.

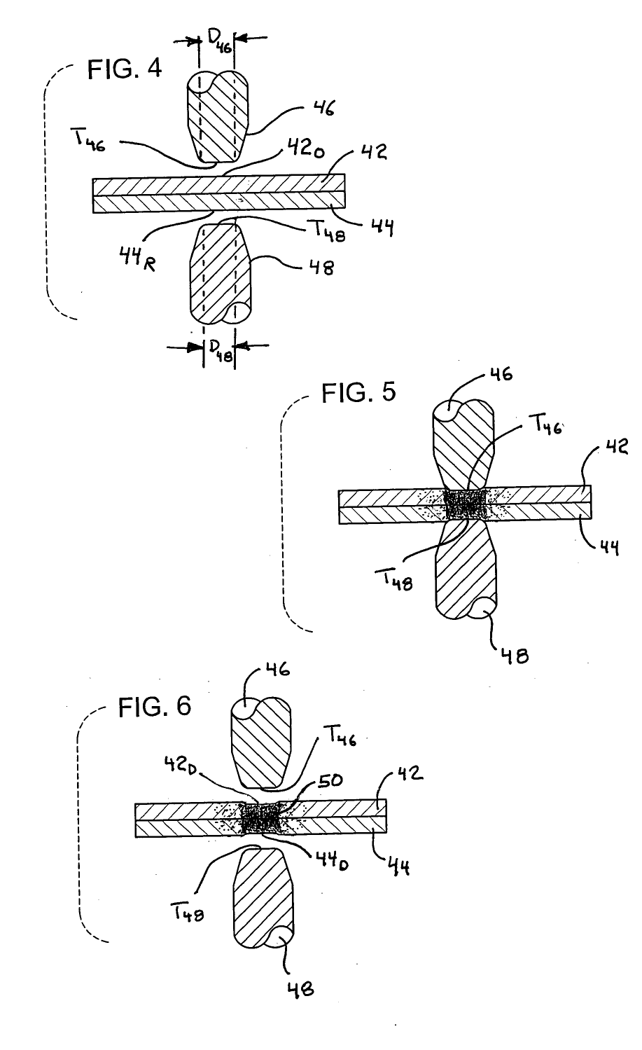

FIG. 4 provides a vertical cross-sectional view of first and second workpieces, with electrodes positioned before start of formation of a weld nugget by resistance spot welding, as shown in FIG. 5.

FIG. 5 provides a vertical cross-sectional view of first and second electrodes acting on obverse and reverse sides of workpieces during the process of formation of a weld nugget.

FIG. 6 provides a vertical cross-sectional view of first and second electrodes being disengaged from the obverse and reverse sides of a weld nugget, after formation of the weld nugget, showing the slight depressions from the spot welding process.

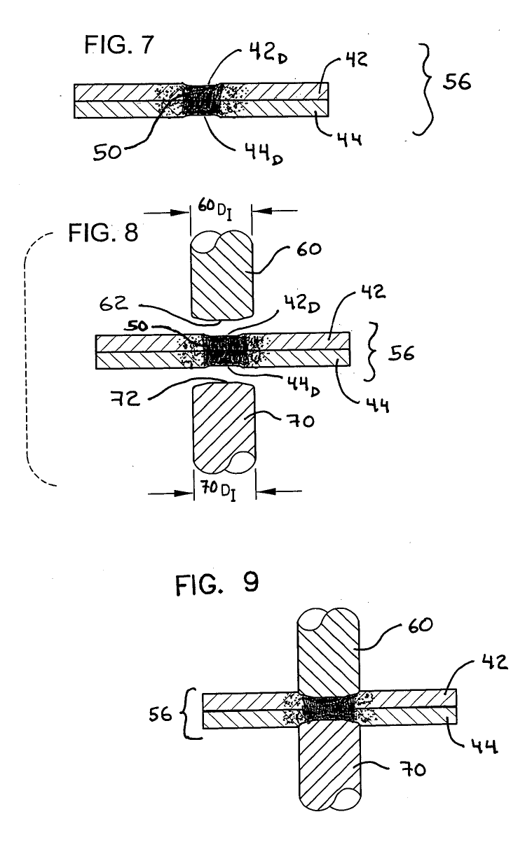

FIG. 7 provides a vertical cross-sectional view of a workpiece in which a weld nugget has been formed, suitable for using first and second indenters to act on obverse and reverse sides of the weld nugget, as taught herein for improvement of fatigue life of spot welded structures.

FIG. 8 provides a vertical cross-sectional view of first and second indenters being set up for acting on obverse and reverse sides of a weld nugget, as taught herein for improvement of fatigue life of spot welded structures.

FIG. 9 provides a vertical cross-sectional view of first and second indenters acting on obverse and reverse sides of work pieces, including the weld nugget, as taught herein for improvement of fatigue life of spot welded structures.

FIG. 10 shows a vertical cross-sectional view of a finished workpiece treated as set forth in FIG. 9, now showing the slight surface depressions in the weld nugget resulting from application of the first and second indenters.

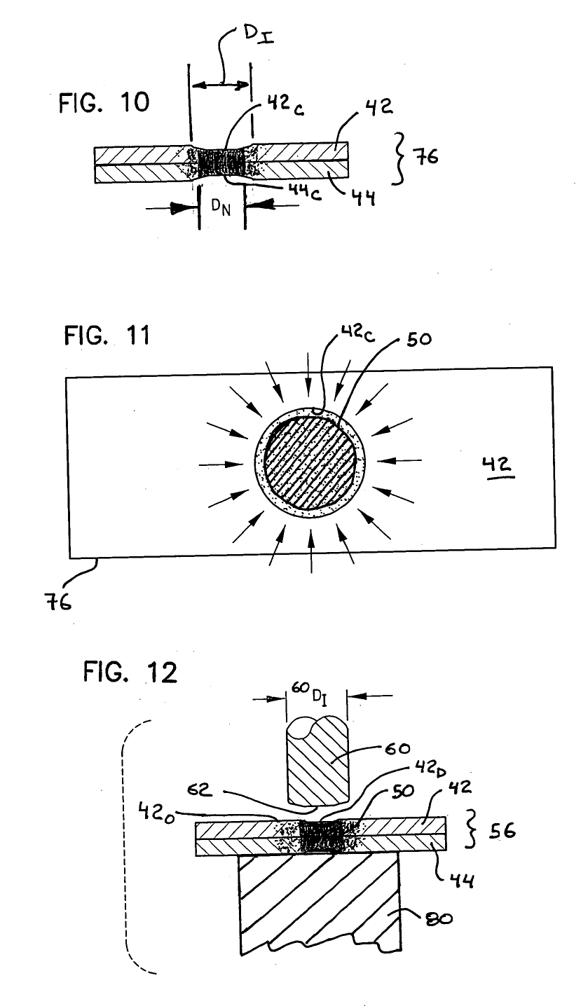

FIG. 11 is a plan view of a workpiece in which first and second metal workpieces have been welded together using a resistance spot weld technique, showing the weld nugget and indicating the use of cold working indenter to treat the weld nugget.

FIG. 12 provides a vertical cross-sectional view of a first indenter and a backing anvil being set up for acting on obverse and reverse sides of a weld nugget, respectively, as taught herein for improvement of fatigue life of spot welded structures.

The foregoing figures, being merely exemplary, contain various elements that may be present or omitted from actual implementations and structural configurations for a resistance spot welded structure with improved fatigue life as taught herein, depending upon the circumstances. An attempt has been made to draw the figures in a way that illustrates at least those elements that are significant for an understanding of the various embodiments and aspects of the invention. However, various elements of the unique treatment process, including optional or alternate features, may be utilized in order to provide a finished, improved fatigue life structure which has been assembled via resistance spot welding.

### DESCRIPTION

The StressWave brand cold working process utilizes indenters to apply work to surfaces of a workpiece, either at or adjacent to a joint location. Since the development of the desirable beneficial residual stresses by the process are not dependent on machining the hole or on the fastener installation, it has been found that the StressWave brand cold working process may be utilized for producing residual stresses at the necessary depth and at a selected magnitude for improving the fatigue life of resistance spot weld joints. Moreover, the StressWave cold working process has been adapted to induce beneficial residual compressive stresses through the thickness of spot welded joints. The beneficial residual compressive stresses imparted by the process improve joint mechanical properties, increase spot welded joint fatigue life, and provide the potential for improving the corrosion resistance of spot weld joints. The process uses shaped indenters that act on one or both of the opposing surfaces of a spot weld nugget, to produce beneficial residual compressive stresses through the entire thickness of a joint, thereby improving fatigue life.

As seen in FIGS. 1 and 2, a typical prior art spot weld process results in a weld nugget 20 joining first metallic sheet 22 and second metallic sheet 24. However, in the assembled workpiece 26, radial inward shrinkage from cooling occurs in the direction of reference arrows 28.

FIG. 3 shows the typical notch roots 30 and 32 formed in an assembled prior art workpiece 26 which has been resistance spot welded. Also shown in FIG. 3 is the location of a typical crack 34 which results in a fatigue failure of the assembled prior art workpiece 26.

Referring now to FIG. 4, a first workpiece 42 and a second workpiece 44 are shown positioned in juxtaposed relationship ready for being bonded together using resistance spot welding. A first electrode 46 and a second electrode 48 are provided, with the first electrode ready to act on the obverse surface 42_{O} of first workpiece 42, and a second electrode 48 ready to act on the reverse surface 44_{R} of the second workpiece 44. In FIG. 5, the first electrode 46 has engaged the obverse surface 42_{O} of first workpiece 42. Likewise, the second electrode 48 has engaged the reverse surface 44_{R} of the second workpiece 44. The spot weld nugget 50 is formed by passing an electrical current through electrodes 46 and 48, and thus through the adjacent, overlapping metallic workpiece 42 and 44 sheets. As the temperature of a localized area of the metallic workpiece sheets 42 and 44 between the electrodes 46 and 48 is elevated by resistance to the flow of electric current, a portion of the metal of each of the workpiece sheets 42 and 44 is heated to a plastic state. As the temperature of the metal of each of the workpiece sheets 42 and 44 increases, a liquid pool of metal forms at the interface of the overlapping metallic workpiece sheets 42 and 44. The liquid pool of metal is typically about the same diameter as the diameter D₄₈ of the tip T₄₈ of electrode 48, and/or of diameter D₄₆ of the tip T₄₆ of electrode 46, which diameters D₄₆ and D₄₈ normally match. Spot weld joints created by this method form welds 50 in the size range of about 8 mm in diameter, known as “buttons”, “fused nuggets” or “weld nuggets” typically identifiable by a slight surface depression, increased surface roughness, and discoloration at the spot weld location. The weld nuggets 50 generally have the shape of a compressed or squeezed cylinder, and have an obverse surface, a reverse surface, and a weld body therebetween As shown in FIG. 5, in typical spot welding applications, the opposing electrodes 46 and 48 also squeeze the metallic workpiece sheets 42 and 44 together prior to and during the flow of electric current. The squeeze force acting on the tips T₄₆ and T₄₈ of the electrodes 46 and 48 improves weld quality and may locally deform the surfaces 40_{O} and 44_{R} of the overlapping metallic workpiece sheets 42 and 44, and form small weld depressions, seen as 42_{D} and 44_{D} in FIG. 6. The partially finished workpiece 56, wherein workpiece 42 and workpiece 44 are joined by weld nugget 50, is shown as assembled in FIG. 7, but before cold working is performed on the partially finished workpiece 56 to improve fatigue life.

Turning now to FIGS. 8 and 9, the partially finished workpiece 56 is shown ready for cold working to improve fatigue life. A first indenter 60 having a diameter 60 D_{I} and a working end 62 is shown ready to engage and indent the obverse side 42_{O} of first workpiece 42. A second indenter 70 having a diameter 70 D_{I} and a working end 72 is shown ready to engage and indent the reverse side 44_{R} of second workpiece 44. In FIG. 9, indenters 60 and 70 are shown acting on partially finished workpiece 56, to create slight surface cold working dimples 42_{C} and 44_{C} as seen in the cold worked worked completed workpiece 76 shown in FIG. 10. Of course, the diameter of dimples 42_{C} and 44_{C} match the shape of the working ends 62 and 72 of the respective indenter, 60 or 70, used to create the cold working dimples 42_{C} and 44_{C}. The dimpling process shown in FIGS. 8 and 8 provides a radial plastic flow of material outward from the center of the weld nugget 50 that sufficiently counteracts the adverse stress created by the radially inward movement of material as indicated in FIG. 1 which typically occurred in the prior art spot weld processes.

In one embodiment, the damaging residual tensile radial stresses from conventional spot welding as indicated in FIG. 1 are replaced by either beneficial compressive residual radial stresses, or a reduction in the radial tensile stress magnitude. Because residual tensile stresses from the spot weld nugget are reduced or replaced with residual compressive stresses, there is potential to improve the corrosion and stress corrosion properties of the joint.

Further, tensile and fatigue tests on carbon steel type 1018 composition which has been treated as indicated in FIGS. 8 and 9 and as generally described herein have shown improvements to tensile mechanical properties such as yield strength and toughness, and have demonstrated a significant increase in fatigue life.

Cold working indenters 60 and 70 are best sized to meet the specific parameters of the spot weld joint, including parent material mechanical properties, spot weld processing, electrode 46 and 48 size, material 42 and 44 thickness, and selected means of indenter actuation.

A spot weld treated by the process described herein will be characterized by a shallow depression on either one or both ends of the weld nugget that differ in size, shape and surface texture from an untreated spot weld nugget. In one embodiment, the depression from the cold working process described herein will be larger in diameter, deeper in depth and smoother, than an untreated spot weld nugget fabricated using conventional spot welding techniques. The cold working process described herein for spot welds can be performed at a selected rate of indenter actuation that meets production requirements, and which is not deleterious to the fatigue benefit desired.

Moreover, the cold working process for spot welds as described herein improves the state of the stress at the notch that is formed from the joining of the sheets 42 and 44 by spot weld nugget 50.

In the method described herein, cold working of a spot weld by use of the StressWave brand cold working process can be practiced to achieve improved mechanical properties in the finished workpiece. In one aspect, such cold working technique can be optimized to achieve improved fatigue life in the finished workpiece. In another aspect, the process can be utilized for the fabrication of joints in steel workpieces. In yet another aspect, the process can be utilized for the fabrication of joints in aluminum workpieces. In yet a further aspect, the process may be optimized for achieving improved corrosion resistance in a spot welded structure. To enhance such a result, a spot weld joint may be indented on one or both sides to achieve improved stress corrosion resistance. In this regard, refer to FIG. 12, wherein the spot weld 50 in partially finished workpiece 56 is worked on surface 42_{O} by indenter 60, while a backing anvil 80 is utilized on the reverse side 44_{I} of sheet 44. In yet another aspect, a spot weld can be cold work by indenting as indicated herein, in order to achieve reduced joint weight.

In various structural assemblies, it may be useful to indent and thus a achieve improved fatigue life in a single spot weld, or in a many spot welds, or a selected pattern of spot welds in a structure having many spot welds, some of which may not be treated, or all of which may be treated.

In practice of the process an indenter 60 or 70 can be selected with a working diameter D that is smaller than the weld nugget 50 diameter D_{N}. Alternately, an indenter 60 or 70 can be selected with a working diameter D that is larger than the weld nugget 50 diameter D_{N}. Or, the indenter diameter D and the weld nugget 50 diameter D_{N} can also be matched, to be roughly or precisely the same diameter.

In another aspect of the process, a two-layer metallic joint, i.e. one made by joining first and second metallic components, can be treated with opposable indenters 60 and 70, one acting on an outer surface of a first component, and one acting on an outer surface of a second component, as illustrated in FIGS. 8 and 9 herein. In yet another aspect of the process, a two-layer metallic joint can be manufactured utilizing one indenter 60 and a backing anvil 80 instead of an opposing indenter, wherein one indenter 60 acts on an outer or obverse surface 42_{O} of a first component such as workpiece material sheet 42, and wherein the anvil 80 backs up an outer or reverse surface 44_{R} of the second component such as workpiece material sheet 44.

Although various aspects and elements of the invention are herein disclosed for illustrative purposes, it is to be understood that a finished spot welded structure with improved fatigue life as described herein is an important improvement in the state of the art of manufacture of spot welded structures. Although only a few exemplary aspects have been described in detail, various details are sufficiently set forth in the figures of the drawing and in the specification provided herein to enable one of ordinary skill in the art to make and use the invention(s), which need not be further described by additional writing in this detailed description. The aspects and embodiments described and claimed herein may be modified from those shown without materially departing from the novel teachings and advantages provided, and may be embodied in other specific forms without departing from the spirit or essential characteristics thereof. It is pointed out that the size and shape of a workpiece, and the number of spot welds on a finished object, will vary widely based on the objectives involved and the individual design preferences of the manufacturer. Therefore, the embodiments presented herein are to be considered in all respects as illustrative and not restrictive. As such, this disclosure is intended to cover the structures described herein and not only structural equivalents thereof, but also equivalent structures. It is therefore to be understood that the invention(s) may be practiced otherwise than as specifically described herein. Thus, the scope of the invention(s) is as described herein and as indicated by the drawing and by the foregoing description, is intended to include variations from the embodiments provided which are nevertheless described by the broad interpretation and range properly afforded to the plain meaning of the language utilized in the accompanying claims.

1. A method of improving fatigue life in spot welded structures, said structures comprising a first metallic component and a second metallic component having at least some portions in back-to-back overlapping relationship, said method comprising:
spot welding said first metallic component to said second metallic component, to provide a spot weld nugget having obverse and reverse sides, to join said first and said second metallic components;
indenting said obverse and or said reverse side of said spot weld nugget to form a dimple in said obverse and or said reverse side of said spot weld nugget.

2. A method of forming a spot weld joint, comprising:
providing a first workpiece and a second workpiece;
welding said first workpiece to said second workpiece at a first weld location to form a spot weld joint;
cold working by indenting at least one of said first or second workpieces by indenting at least a portion of said spot weld joint and thereby inducing residual compressive stress in at least a portion of said first and said second workpiece at a location adjacent said spot weld joint.

3. A method according to claim 2, further comprising cold working at least a portion of said first or said second workpiece in at least a portion of said first or said second workpiece adjacent said spot weld joint.

4. A method according to claim 1 or claim 2, wherein indenting is accomplished utilizing a shaped indenter.

5. A method according to claim 2, wherein said weld joint comprises a resistance spot weld.

6. A method according to claim 2, wherein said resistance spot weld is substantially circular in shape.

7. A method according to claim 6, wherein indenting is accomplished utilizing an indenter comprising a working end having rounded edge portions.

8. A method according to claim 6, wherein indenting is accomplished utilizing an indenter comprising a working end having beveled edge portions.

9. A method according to claim 6, wherein said indenter comprises a working end comprising a flat central portion.

10. A method according to claim 6, wherein said indenter comprises a working end comprising a rounded central portion.

11. A method according to claim 2, wherein said weld joint comprises a resistance spot weld joint comprising a weld nugget, said weld nugget at least somewhat resembling a squeezed cylinder shape having an obverse surface and reverse surface and a weld body therebetween.

12. A method according to claim 11, wherein said weld nugget has a diameter D_{N}, and wherein said indenter has a diameter D_{I}, and wherein the ratio of the diameter D_{I} to the diameter D_{N} is selected to provide fatigue life improvement properties in a finished workpiece.

13. A method according to claim 12, wherein the ratio of D_{I} to D_{N} is greater than 1.

14. A method according to claim 13, wherein the ratio of D_{I} to D_{N} is approximately 1.

15. A method according to claim 13, wherein the ratio of D_{I} to D_{N} is less than 1.

16. A method according to claim 2, wherein cold working of at least one of said first or second workpiece comprises indenting at least a portion of said weld nugget at a pre-selected depth of indentation.

17. A method according to claim 2, wherein cold working is performed using an indenter on said first workpieces and a backing anvil is used adjacent said second workpiece.

18. A method according to claim 16 wherein cold working of at least one of said first or second workpieces comprises selecting an indenter force commensurate with the material properties of said first or said second workpiece, to provide a dimple in at least a portion of said weld nugget of selected depth.

19. A method for forming a weld joint, comprising: forming a resistance spot weld joint along between adjacent surfaces of two workpieces and leaving a weld nugget, and subsequently cold working said weld nugget and a portion of the surface of each of said two workpieces adjacent said weld nugget with an shaped indenter to impart a residual dimple shape in at least a portion of said surfaces adjacent said weld nugget, to impart a beneficial residual stress in at least a portion of each of said two workpieces adjacent said weld nugget, to thereby increase fatigue life of said weld joint.

20. A structural assembly, comprising:
at least one workpiece having a first portion;
a weld joint disposed to join said first portion of said at least one workpiece with a workpiece;
wherein, at least a portion of the weld joint and said first portion of said at least one workpiece adjacent the weld joint comprise a selectively formed pattern of beneficial residual stress to thereby improve the corrosion resistance and fatigue strength of said weld joint and of said at least one workpiece.

21. A structural assembly according to claim 20, wherein said selectively formed pattern of residual stress comprises radially inward residual compressive stress.

22. A structural assembly, comprising:
a first structural member;
a second structural member positioned adjacent to said first structural member to thereby define an interface therebetween;
at least one spot weld joining said first and second structural members, said spot weld providing a weld nugget; and
wherein said structural assembly is cold worked by application a selected force by one or more indenters to at least a portion of said weld nugget, to form a residual dimple in at least a portion of said weld nugget.

23. A structural assembly according to claim 22 wherein said first and said second structural members comprise the same material.

24. A structural assembly according to claim 22 wherein said first and said second structural members comprise carbon steel.

25. A structural assembly according to claim 22 wherein said first and said second structural members comprise aluminum.

26. A structural assembly according to claim 22, wherein said weld nugget is formed in the shape of a compressed cylinder having an obverse surface, a reverse surface, and a body therebetween.

27. A structural assembly according to claim 26, wherein cold working is performed in a region adjacent to said weld nugget in each of said first and said second structural members.
